(19) United States
(12) Patent Application Publication
(10) Pub. No.: US 2026/0086295 A1
(43) Pub. Date: Mar. 26, 2026

(54) ALIGNMENT ARRANGEMENT FOR ALIGNING A FIRST AND A SECOND OPTICAL COMPONENT AS WELL AS A CORRESPONDING SYSTEM

(71) Applicant: MicroAlign B.V., EINDHOVEN (NL)

(72) Inventors: Marco FATTORI, EINDHOVEN (NL); Simone CARDARELLI, EINDHOVEN (NL); Antonio ASTORINO, EINDHOVEN (NL); Jaap Petrus Maria VERHEGGEN, EINDHOVEN (NL); Hendrikus Wilhelmus Leonardus Antonius Maria VAN LIEROP, EINDHOVEN (NL)

(21) Appl. No.: 19/112,344

(22) PCT Filed: Sep. 19, 2023
(86) PCT No.: PCT/NL2023/050483

§ 371 Date: Mar. 17, 2025

(30) Foreign Application Priority Data
Sep. 19, 2022 (NL) 2033074

(51) Int. Cl. G02B 6/36; G02B 6/42

(52) U.S. Cl. CPC G02B 6/3656; G02B 6/3652; G02B 6/3664; G02B 6/4226

(57) ABSTRACT

The present invention relates in a first aspect to an alignment arrangement for aligning a first and a second optical component, wherein at the least the first optical component of the alignment arrangement comprises at least one optical fiber. The alignment arrangement comprises a number of cantilevers corresponding to the number of optical fibers in the first optical component. Each cantilever is fixed at one end to the alignment arrangement, and at an opposite free end comprises a support tip having a groove for receiving a respective optical fiber of the first optical component. Each cantilever is arranged for deflecting in an X-direction perpendicular to the longitudinal direction of the cantilever, and in a Y-direction perpendicular to the X-direction and perpendicular to the longitudinal direction of the cantilever. Each cantilever comprises at least one piezoelectric element for providing said deflection in the X- and Y-direction by actuating the piezoelectric element with at least two electrodes. The invention relates in a second aspect to an alignment arrangement for aligning a first and a second optical component, wherein at the least the first optical component of the alignment arrangement comprises at least one lens. The present invention relates in a third aspect to a system for optically connecting an on-chip port of a first chip with an on-chip port of a second chip.

### TECHNICAL FIELD

The present invention relates to photonic assembly/testing and, more specifically, to an alignment arrangement for aligning a first and a second optical component. The present invention is further related to a system for optically connecting an on-chip port of a first chip with an on-chip port of a second chip.

### BACKGROUND

Photonic packaging is the assembly procedure encapsulating photonic chips in reliable protection packages, providing electrical and/or optical interfaces between the photonic chip and the user. Photonic packaging can in part rely on the experience of the electronics industry to successfully implement several assembly operations, however, the connection between photonic chips and optical components like optical fibers and lenses requires submicron-scale alignment and represents a new critical assembly challenge.

Optical fibers are often used to create connectivity with and between photonic chips. The efficient connection between a single on-chip port and an optical fiber requires submicron scale and controlled alignment, commonly performed by means of micro-manipulators. Connectivity with a photonic chip with multiple ports can be established through an array of optical fibers, which is commercially available as a single unit containing pre-aligned optical fibers. Each on-chip port has to be geometrically mated with a fiber port, typically named as fiber core.

Efficient alignment between the on-chip ports (perfectly aligned) and the array of optical fibers is compromised by the imperfect position of each fiber core in the array, therefore, alternative solutions are required. This motivates the investigation of efficient methods for the alignment of multiple optical fibers with multi-port photonic chips.

EP4028809A1 discloses an apparatus arranged for moving a part of or an entire optical component for alignment purposes of the optical component with a further optical component. The disclosed apparatus has a plurality of mechanically independent and adjacently placed elongated carriers (cantilevers) comprising piezoelectric material configured to deflect the carrier in a direction perpendicular to the longitudinal direction. Deflection is achieved by applying voltage to the piezoelectric material. Two adjacent mechanically independent cantilevers are employed to achieve two-dimensional alignment of a single optical fiber. Moving a single cantilever however affects both the lateral as well as the transversal alignment of the optical fiber. Additionally, moving a single cantilever will induce sliding of the optical fiber over the cantilever tips, which again will lead to stick-slip effects. The vertical and horizontal actuation range depends on the side wall angle of the cantilevers supporting the optical fibers, furthermore, stick-slip effects between the optical fiber and cantilever may impact the smoothness and predictability of the alignment procedure.

CN102176506B discloses a lateral MEMS micro-actuator driven by a piezoelectric thick film. The micro-actuator includes a “T”-shaped cross-section cantilever beam, and is designed for lateral (in-plane) motion. Due to this vertical segment in this “T”-shape, the out-of-plane stiffness (in the vertical direction) is very high, effectively suppressing any out-of-plane displacement. Such a cantilever beam can therefore provide only lateral displacement.

US 2009/235396 A1 discloses an apparatus comprising a MEMS for providing image acquisition and/or image display in a limited region of interest. Electrostatic effects are used for vertical and horizontal actuation, placing the electrodes at a distance from the cantilever.

JP S63150603 A discloses an optical fiber core connecting device having of a V-groove substrate with a bimorph piezoelectric element that is used move each side of the V groove. The optical fiber entails deflecting the end of the optical fiber core by sliding said end up or down on the actuators.

Martin Hoffman et al., “All-silicon bistable micromechanical fiber switch based on advanced bulk micromachining”, IEEE Journal of Selected Topics in Quantum Electronics, IEEE, USA, p.5-1, 1999 relates to all-silicon bistable micromechanical fiber switch based on advanced bulk micromachining. The switching entails a horizontal deflection of the fiber, while keeping the vertical position fixed by a fixed clamp.

There is a need for an improved arrangement for aligning a first optical component to a second optical component, specifically for a more accurate and smooth alignment, and providing both lateral as well as transverse displacement

### SUMMARY

It is an object of the present invention to provide an improved alignment arrangement for aligning a first and a second optical component.

It is a further object of the present invention to provide an alignment arrangement for aligning a first and a second optical component for a more smooth alignment.

It is a further object of the present invention to provide a system for optically connecting an on-chip port of a first chip with an on-chip port of a second chip.

The present invention relates in a first aspect to an alignment arrangement for aligning a first and a second optical component according to the present invention. At the least the first optical component of the alignment arrangement comprises at least one optical fiber. The alignment arrangement comprises a number of cantilevers. Each cantilever is fixed at one end to the alignment arrangement, and at an opposite free end comprises a support tip having a groove for receiving a respective optical fiber of the first optical component. Each cantilever is arranged for deflecting in an X-direction perpendicular to the longitudinal direction of the cantilever, and in a Y-direction perpendicular to the X-direction and perpendicular to the longitudinal direction of the cantilever. Each cantilever comprises at least one piezoelectric element for providing said deflection in the X-and Y-direction by actuating the piezoelectric element with at least two electrodes.

In a second aspect, the invention relates to an alignment arrangement similar to the arrangement of the first aspect but different in that the first optical component comprises at least one lens.

The present invention relates in a third aspect to a system for optically connecting an on-chip port of a first chip with an on-chip port of a second chip, wherein the system comprises an alignment arrangement according to the first or second aspect for aligning the on-chip port of the first chip with a first optical component.

One or more of these objects is achieved by the alignment arrangement for aligning a first and a second optical component according to the present invention, or the system for optically connecting an on-chip port of a first chip with an on-chip port of a second chip according to the present invention.

Without wishing to be bound by theory, the inventors believe that a more accurate alignment is achieved with the present invention because it is not affected by friction between the fiber and the groove walls. It is further believed that the alignment will be fast because the alignment can take place simultaneously in lateral and transverse direction across multiple cantilevers, and because the movement will be more controllable due to the absence of friction. This enables alignment of optical components in a high-density linear array or in a 2D array configuration, and allow for such alignment in two orthogonal dimensions independently of each other.

### BRIEF DESCRIPTION OF DRAWINGS

The present invention is described hereinafter with reference to the accompanying drawings in which embodiments of the present invention are shown and in which like reference numbers indicate the same or similar elements.

FIG. 1 shows an example of an alignment arrangement according to the present invention, in use.

FIG. 2 shows the alignment arrangement of FIG. 1, not in use.

FIG. 3 shows an example of a cantilever as comprised in the alignment arrangement according to the present invention.

FIG. 4 shows the cantilever of FIG. 1 in movement. FIG. 4A shows an out-of-plane motion of the cantilever. FIG. 4B shows in in-plane motion of the cantilever. FIG. 4C shows a combined out-of-plane and in-plane motion of the cantilever.

FIG. 5 shows different examples of the support tip as comprised in the alignment arrangement according to the present invention.

FIG. 6A shows a top view of an example of a cantilever which may be comprised in the alignment arrangement according to the present invention. FIG. 6B shows its cross-section.

FIG. 7A shows a top view of an example of a cantilever which may be comprised in the alignment arrangement according to the present invention. FIGS. 7B and 7C show its possible cross-sections.

FIG. 8A shows a top view of an example of a cantilever which may be comprised in the alignment arrangement according to the present invention. FIG. 8B shows its cross-section.

FIG. 9A shows a side view of an example of a cantilever which may be comprised in the alignment arrangement according to the present invention. FIG. 9B-F show its possible cross-sections.

FIG. 10A and FIG. 10B show side views of examples of a cantilever which may be comprised in the alignment arrangement according to the present invention.

FIG. 11A-E show cross-sectional views of examples of a cantilever which may be comprised in the alignment arrangement according to the present invention.

### LIST OF DEFINITIONS

The following definitions are used in the present description and claims to define the stated subject matter. Other terms not cited below are meant to have the generally accepted meaning in the field.
“Optical fiber” as used in the present description means: a flexible fiber, made of glass or a polymer, that guides light
“Cantilever” as used in the present description means: a structural element that extends horizontally and is supported at only one end. In the alignment arrangement according to the present inventive, multiple deformable cantilevers can be attached to the arrangement for instance in a comb-like fashion.
“Groove” as used in the present description means: a space or lodging structure capable to receive for an optical fiber.
“Piezoelectric element” as used in the present description means: a material that generates an electric charge in response to applied mechanical stress. The reverse effect can also be achieved: by applying an electrical field to the material, the material expands or contracts and can be used as actuator to move objects with extreme accuracy. Examples of materials that exhibit piezoelectricity are crystalline materials such as quartz, ceramics, group III-V and II-VI semiconductors, and polymers.
“Electrode” as used in the present description means: an electrically conductive layer, often a metal, or semiconductor, or made by carbon fibers, on top, underneath, or in between one or more layers of piezoelectric material.

### DESCRIPTION OF EMBODIMENTS

Embodiments of the alignment arrangement according to the first aspect of the present invention are described below. Corresponding embodiments are also applicable for the alignment arrangement according to the second aspect of the present invention, as well as to the system according to the third aspect of the present invention.

As stated above, the invention relates in a first aspect to an alignment arrangement for aligning a first and a second optical component.

At the least the first optical component of the alignment arrangement comprises at least one optical fiber. The alignment arrangement can be scaled to comprise any number of optical fibers. For instance, the first optical component may comprise between 1 and 64 fibers.

The alignment arrangement comprises a number of cantilevers. The number of cantilevers is at least one.

Each cantilever is fixed at one end to the alignment arrangement, and at an opposite free end comprises a support tip having a groove for receiving a respective optical fiber of the first optical component.

Each cantilever is arranged for deflecting in an X-direction perpendicular to the longitudinal direction of the cantilever, and in a Y-direction perpendicular to the X-direction and perpendicular to the longitudinal direction of the cantilever.

Each cantilever comprises at least one piezoelectric element for providing said deflection in the X- and Y-direction by actuating the piezoelectric element with at least two electrodes. In an embodiment, each cantilever comprises two active electrodes and a common electrode. With “active” in this context is meant that the voltage applied to the related electrode can be tuned.

In case the electrical control is based on two active electrodes, two independent electrodes may be applied to the piezo material. The electrodes are elongated along the length of the cantilever, and can be as long as the cantilever or shorter. The two electrodes are positionally on the right and left side with respect to the center of the groove.

The common electrode may be under or inside the cantilever to be used as reference electrode. The two active electrodes can be biased with positive or negative voltage with respect to the common electrode. The common electrode can be metal, carbon fiber based electrically conductive material, or semiconductor material.

Horizontal (lateral) alignment can be achieved by applying positive voltage to one active electrode and negative voltage to the opposite active electrode. Vertical displacement can be achieved by applying the same voltage to both the active electrodes. Worded differently, a common mode signal applied to the active electrodes will lead to vertical (transverse) displacement. A differential mode signal will lead to horizontal displacement. The applied voltage results in different direction of the mechanical displacement if the piezoelectric material is poled differently. Alternatively, the alignment can be achieved by applying an electrical charge to the electrodes, instead of applying a voltage. Using a charge control feedback loop allows for a more linear response of the displacement, as hysteresis can be reduced. Thus, in an embodiment, said deflection in the X- and Y-direction is controlled by applying at least two independently controlled voltages or electrical charges to the electrodes.

A two-dimensional displacement can be achieved with the remaining combinations of pairs of voltages applied to the electrodes, defining a typical rhombus shaped 2D-displacement range. For example, in the case that there is a cantilever with two active electrodes, zero voltage (V1=V2=0) is applied to both the electrodes in case of the centered position. An identical voltage is applied to both electrodes (V1=V2) to achieve a vertical displacement, opposite voltages are applied to the electrodes (V1=V2) to achieve horizontal displacement. A not specific combination of voltages V1 and V2 can be applied to the electrodes to implement a diagonal displacement direction. The fiber can reach any point within the geometrical area defined by the rhombus contour formed by the maximum horizontal and vertical displacements, by applying the proper combination of voltages to the active electrodes. Similary, this can be achieved by applying an electrical charge instead of a voltage.

In an embodiment of the first aspect, the cantilever comprises 4 electrodes.

In an embodiment, at least one electrode of the at least two electrodes provides said deflection in the X-direction and at least one further electrode of the at least two electrodes provides said deflection in the Y-direction.

In an embodiment, each cantilever is arranged to maintain a relative position of a respective optical fiber in respect of said groove. In other words, the optical fiber moves with the cantilever. In this embodiment, each cantilever serves as the sole supportive surface for the respective optical fiber. That is to say: there is no element that is separate from the cantilever fixating or otherwise influencing the position of the fiber. This is contrary to e.g. a switch, wherein the vertical position of the optical fiber is fixated by an element (e.g. clamp) outside the cantilever. It is possible to include more cantilevers than there are optical fibers in the arrangement, allowing for alignment of a different number of optical fibers with alignment arrangements with the same number of cantilevers. It is also possible to include less cantilevers than there are optical fibers, for instance in case some optical fibers do not require accurate alignment, or in case some optical fibers have already been aligned in a previous step. In an embodiment, the number of cantilevers corresponds to the number of optical fibers in the first optical component.

In a further embodiment, each cantilever comprises two adjacently placed beams mutually connected at least at the support tip, each beam comprising either a piezoelectric element or an electrode of a piezoelectric element. The length of the (unconnected) beams compared to the length of the connected section influences the lateral displacement gained by the alignment arrangement. An alternative way of describing the presence of separate beams is that the cantilever may exhibit a slit in the longitudinal direction (wherein the slit does not extend all the way up the support tip). These beams or this slit improves deflection along the lateral axis.

In an embodiment, each cantilever comprises two vertically stacked beams mutually connected at least at the support tip, each beam comprising either a piezoelectric element or an electrode of a piezoelectric element. This can be seen as a bunk-bed arrangement.

In yet another embodiment, the cantilevers comprise three or more mutually connected beams.

The groove facilitates lodging of the fiber on the cantilever with accurate spacing and position. The groove of the support tip may have any cross-sectional shape that forms a receiving space for an optical fiber. In an embodiment, the groove of the support tip has a V-shaped or curved shape cross section. In a specific embodiment, the groove of the support tip has a V-shaped cross-section wherein the slopes of each side are between 20 and 80 degrees. The extend of the groove may be limited to the support tip. The groove may also extend further along the cantilever, toward the base of the cantilever. The groove may be as long as the cantilevers.

In an embodiment, the cantilever is monolithically connected with its support tip. In a different embodiment, they are not monolithically connected, but integrated after being fabricated independently. The support tip may consist or comprise of a different material than the rest of the cantilever. The cantilever can be manufactured by known manufacturing technologies for microelectromechanical systems, including wafer bonding and chemical etching of the support top. It may also be manufactured via moulding, deposition, or 3D-printing of the support tip on the cantilever.

In an embodiment, the second optical component is any of an optical fiber, an optical lens, a port of an optical chip, a waveguide or an optical aperture.

In an embodiment, the cantilever has a length of between 0.5 cm-5 cm in the longitudinal direction.

In an embodiment, the thickness of the cantilever, as measured in the transverse direction, is smaller than its width, as measured in the lateral direction. Having a low thickness allows for a large transverse displacement. Preferably, the thickness is less than half the width. More specifically, the thickness is preferably smaller than 250 μm. This thickness includes the thickness of the piezoelement.

In an embodiment, multiple layers of piezoelectric material may be combined with multiple electrode layers. Thereby creating a sandwich structure of piezoelectric layers and electrodes. Such a configuration may be used to increase the stroke, force, or stiffness of the cantilever beam. If two layers of piezoelectric material are used, then a bimorph is created. In between those two layers, a third layer may be used to provide additional mechanical robustness, stiffness, or to improve manufacturability.

The alignment arrangement according to the first aspect of the present invention can be used in a high-density linear array.

The alignment arrangement according to the first aspect of the present invention can also be used for alignment of a two-dimensional array.

As stated above, the invention relates in a second aspect to an alignment arrangement for aligning a first and a second optical component, wherein at the least the first optical component of the alignment arrangement comprises at least one lens. The alignment arrangement comprises a number of cantilevers. The number of cantilevers is at least one. Each cantilever is fixed at one end to the alignment arrangement, and at an opposite free end comprises a support tip having a groove for receiving a respective lens of the first optical component. Each cantilever is arranged for deflecting in an X-direction perpendicular to the longitudinal direction of the cantilever, and in a Y-direction perpendicular to the X-direction and perpendicular to the longitudinal direction of the cantilever. Each cantilever comprises at least one piezoelectric element for providing said deflection in the X- and Y-direction by actuating the piezoelectric element with at least two electrodes.

The embodiments as described above for the alignment arrangement according to the first aspect are applicable correspondingly to this alignment arrangement according to the second aspect.

As stated above, the present invention relates in a third aspect to a system for optically connecting an on-chip port of a first chip with an on-chip port of a second chip. The system comprises an alignment arrangement according to the first or second aspect of the present invention for aligning the on-chip port of the first chip with a first optical component.

The first and the second photonic chips are at a distance, for which optical lenses may be used to optically connect the first and second chip. A first set of lenses may be used in proximity of the first chip to direct the optical beams radiated from the ports of the first chip towards the respective ports of the second chip. A second set of lenses may be used in proximity of the second chip to collect the beams coming from the first chip. Additional optical elements may be used in between those lenses, including but not limited to mirrors, prisms, optical fibers, or additional lenses. Alignment of each lens of the two sets of lenses can be performed by the alignment arrangement according to the first or second aspect of the present invention.

It is possible that a first alignment arrangement is connected with the first set of lenses, and a second alignment arrangement is connected with the second set of lenses. Hence, in an embodiment of the third aspect, the system further comprises a second alignment arrangement according to the first or second aspect for aligning the on-chip port of the second chip with the first optical component or with a second optical component; such that the first optical component is aligned with the on-chip port of the second chip via the optical component or components.

### DETAILED DESCRIPTION OF FIGURES

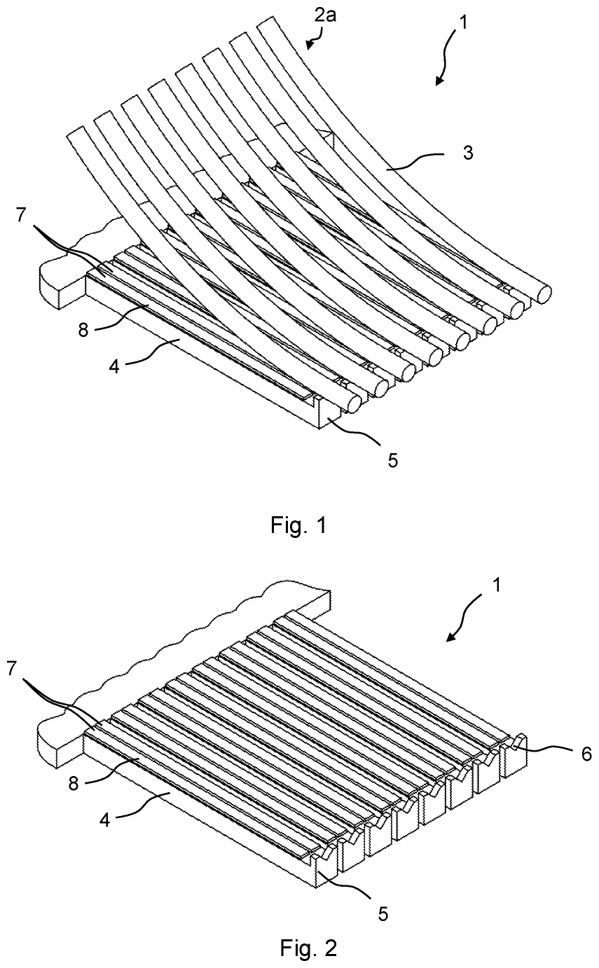

FIG. 1 shows an alignment arrangement (1) according to the first aspect of the present invention. The first optical component (2a) comprises optical fibers (3). The alignment arrangement (1) comprises a number of cantilevers (4), wherein each cantilever is fixed at one end to the alignment arrangement (1), and at an opposite free end comprises a support tip (5) having a groove (not visible) for receiving a respective optical fiber (3) of the first optical component (2a). Each cantilever (4) is arranged for deflecting in an X-direction perpendicular to the longitudinal direction of the cantilever (4), and in a Y-direction perpendicular to the X-direction and perpendicular to the longitudinal direction of the cantilever (4). Each cantilever comprises a piezoelectric element (7) for providing said deflection in the X- and Y-direction by actuating the piezoelectric element (7) with two electrodes (8).

FIG. 2 shows alignment arrangement (1) of FIG. 1, now without the optical fibers (3). The groove (6) of the support tip (5) is now visible. In this example, the groove has a V-shaped cross-section.

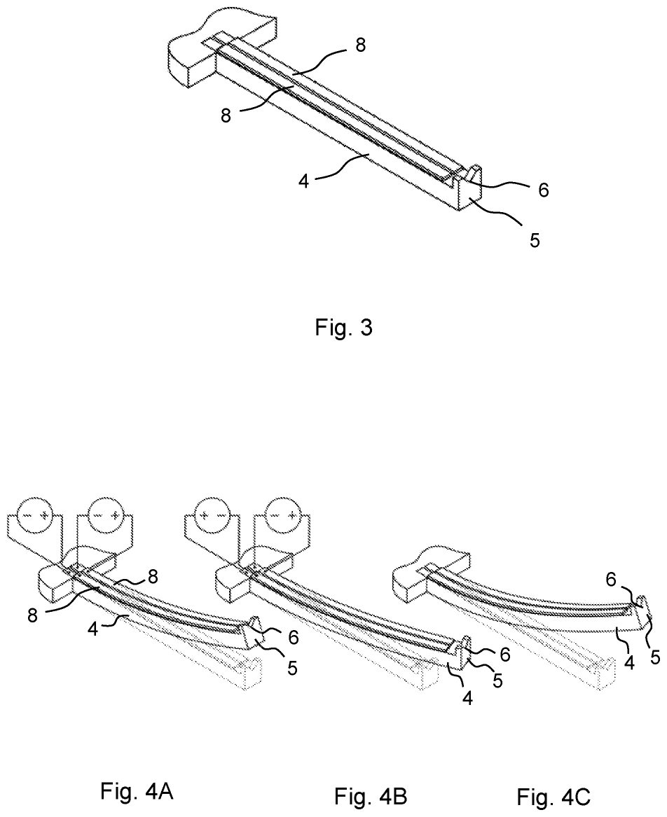

FIG. 3 shows an example of a cantilever (4) as comprised in the alignment arrangement (1) according to the present invention. The cantilever comprises a support tip (5) having a groove (6) for receiving an optical fiber (not shown). In this example, the groove has a V-shaped cross-section. The cantilever (4) comprises two piezoelectric elements (not visible beneath the electrodes)) with two electrodes (8) each, one at the top, and one at the bottom of each piezo electric element.

FIG. 4 shows the cantilever of FIG. 3 in movement. FIG. 4A shows an out-of-plane or transverse motion of the cantilever (4). FIG. 4B shows in-plane or lateral motion of the cantilever (4). FIG. 4C shows a combined out-of-plane and in-plane motion of the cantilever (4). Two independent electrodes (8) are applied on top of the piezo material. An additional two electrodes (not visible) are located underneath the piezo material. The electrodes are elongated along the length of the cantilever (4). The four electrodes are positionally on the right and left side with respect to the center of the groove (6). Lateral displacement of the support tip (5) can be achieved by applying positive voltage across one set of electrodes and negative voltage across the opposite set of electrodes. Transverse displacement can be achieved by applying the same voltage to both sets of electrodes. A two-dimensional displacement can be achieved with the remaining combinations of pairs of voltages applied to the electrodes.

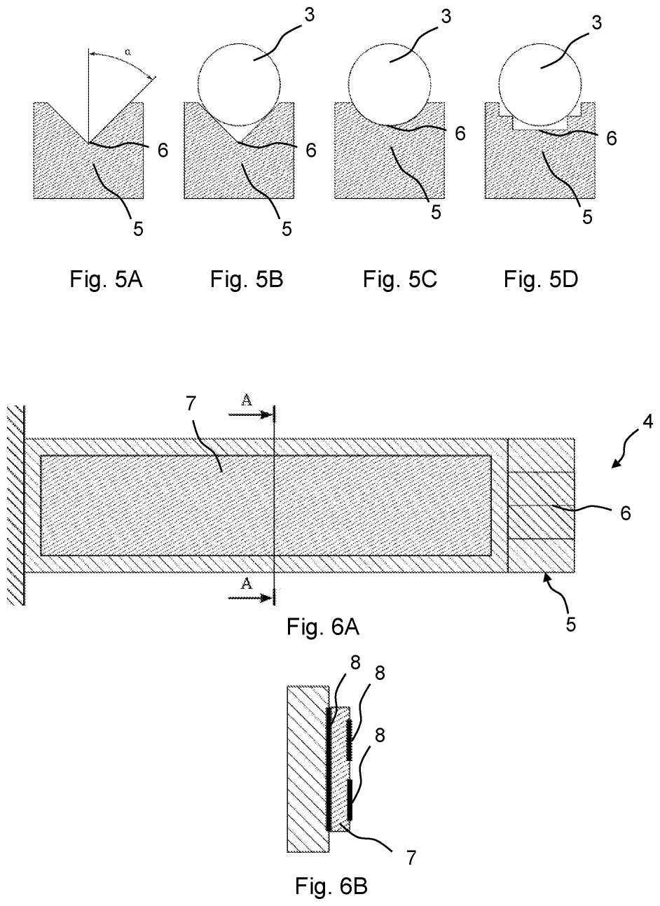

FIG. 5 shows different examples of the shape of the groove (6) of the support tip (5). The support tip (5) may have a V-shaped cross-section, as shown in FIGS. 5A and 5B. FIG. 5A indicates an angle a of the slopes forming the V-shape. These slopes are for example between 20 and 80 degrees. FIG. 5B shows how an optical fiber (3) may be held within the groove (6). FIG. 5C shows a support tip (5) wherein the groove (6) has a curved-shaped cross-section, which in this example describes part of a circle. In this example, the groove has a shape and size to exactly fit an optical fiber (3). In FIG. 5C the support tip (5) has a step-shaped groove (6) in cross-section. The optical fiber (3) is placed within this groove (6).

FIG. 6A shows a top view of an example of a cantilever (4) which may be comprised in the alignment arrangement according to the present invention. FIG. 6B shows its cross-section. The piezoelectrical element (7) has, in this example, three electrodes (8). The electrodes are not shown in FIG. 6A but can be seen in FIG. 6B. One of the electrodes (8), the common electrode, is located underneath of the piezoelectric element (7). The two active electrodes (8) are located on top of the piezoelectric element (7).

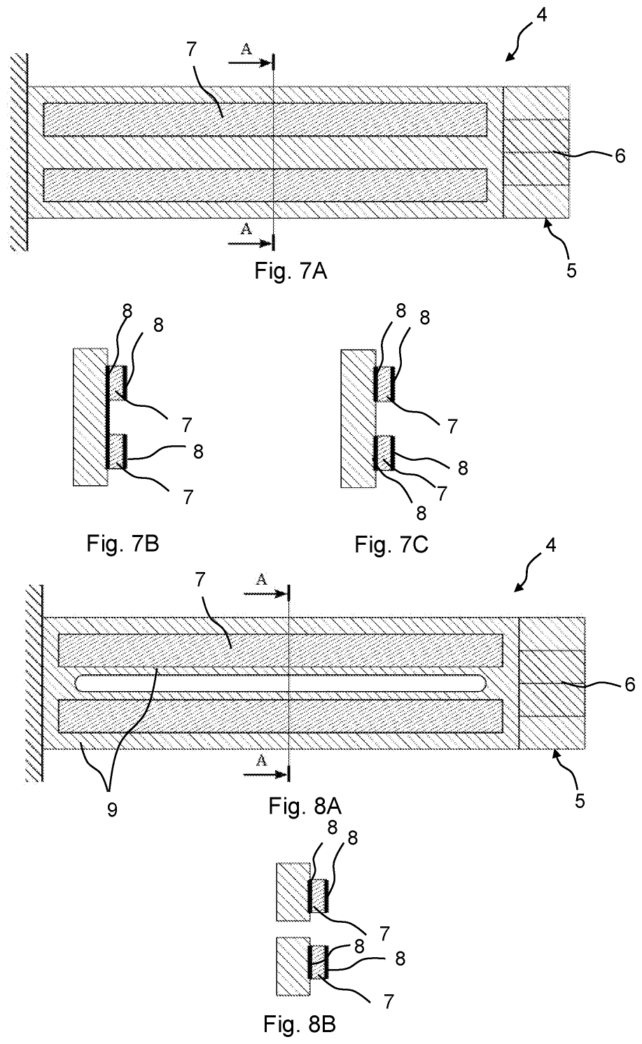

FIG. 7A shows a top view of an example of a cantilever (4) which may be comprised in the alignment arrangement according to the present invention. FIGS. 7B and 7C show its possible cross-sections. In this example, the cantilever comprises two piezoelectric elements (7). FIGS. 7B and 7C show examples of the electrodes in cross-section, wherein FIG. 7B shows an example with three electrodes, and FIG. 7C shows an example of 4 electrodes.

FIG. 8A shows a top view of an example of a cantilever (4) which may be comprised in the alignment arrangement according to the present invention. FIG. 8B shows its cross-section. The cantilever (4) has two adjacently placed beams (9) which are connected at the support tip (5). FIG. 8B shows that each beam has its own piezoelectric element (7), each comprising two electrodes (8).

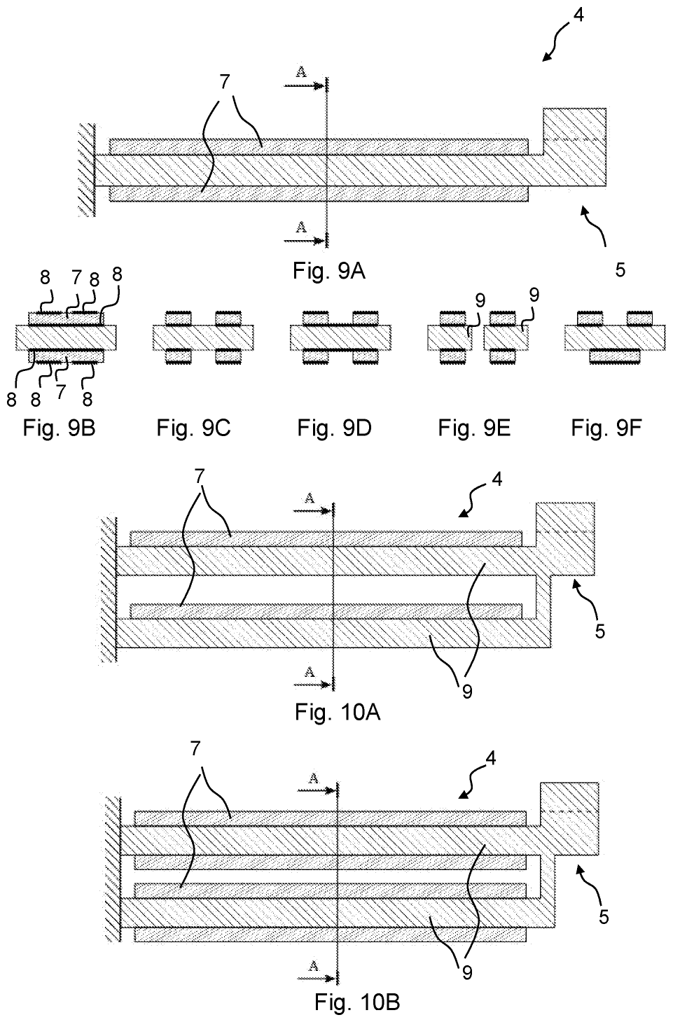

FIG. 9A shows a side view of an example of a cantilever (4) which may be comprised in the alignment arrangement according to the present invention. The cantilever (4) comprises one or two piezoelectric elements (7) on top of the cantilever (4) and another one or two piezoelectric elements (7) on the bottom side of the cantilever (4). FIG. 9B-F show its possible cross-sections, wherein the reference signs are only included in FIG. 9B but are applicable correspondingly to FIG. 9C-F. Each piezoelectric element (7) may comprise 2 or 3 electrodes (8), as shown in the cross-sectional views of FIG. 9B-9F. The cantilever (4) of FIG. 9E comprises two adjacently located beams (9).

FIG. 10A and FIG. 10B show side views of examples of a cantilever (4) which may be comprised in the alignment arrangement according to the present invention. The cantilever (4) comprises two beams (9) which are located on top of each other. This can be described as a bunk-bed arrangement. The beams (9) are connected at the support tip (5). There is a piezoelectric element (7) on top of each beam (9), and in FIG. 10B there are also piezoelectric elements (7) underneath each beam (9). As shown in the previous figures, each piezoelectric element (7) may have different arrangements of the electrodes.

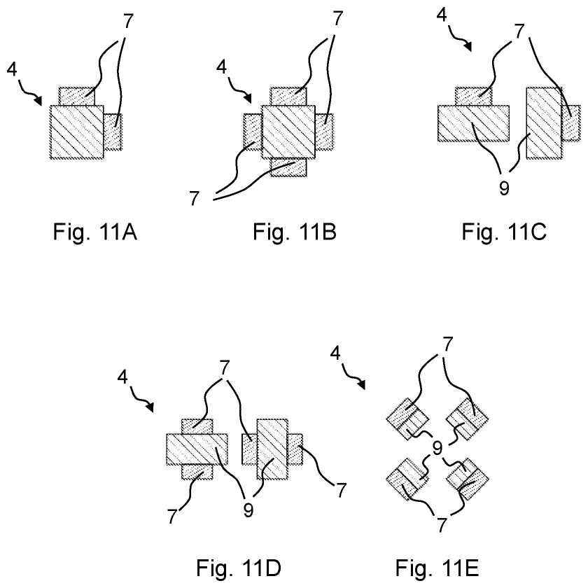

FIG. 11A-E show cross-sectional views of examples of a cantilever (4) which may be comprised in the alignment arrangement according to the present invention. In FIG. 11A, the cantilever (4) has two piezoelectric elements (7), one located on the top of the cantilever (4), one at a side. FIG. 11B shows a cantilever (4) with four piezoelectric elements (7), one on each side. FIG. 11C shows an example of a cantilever (4) comprising two beams (9), each with one piezoelectric element (7). As shown, the beams (9) can have different thicknesses and widths, and the piezoelectrical elements (7) can be located on different sides of the beams (9). FIG. 11D shows an example of a cantilever (4) comprising two beams (9), each with two piezoelectric elements (7). As shown, the beams (9) can have different thicknesses and widths, and the piezoelectrical elements (7) can be located on different sides of the beams (9). FIG. 11E shows an example of a cantilever (4) comprising four beams (9), each with one piezoelectric element (7). As shown, the beams (9) can have different thicknesses and widths, as well as angles, and the piezoelectrical elements (7) can be located on different sides of the beams (9).

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope thereof.

The scope of the present invention is defined by the appended claims. One or more of the objects of the invention are achieved by the appended claims.

1. Alignment arrangement (1) for aligning a first and a second optical component (2a, 2b),
wherein at the least the first optical component (2a) comprises at least one optical fiber (3),
wherein the alignment arrangement (1) comprises a number of cantilevers (4), wherein each cantilever is fixed at one end to the alignment arrangement (1), and at an opposite free end comprises a support tip (5) having a groove (6) for receiving a respective optical fiber (3) of the first optical component (2a),
wherein each cantilever (4) is arranged for deflecting in an X-direction perpendicular to the longitudinal direction of the cantilever (4), and in a Y-direction perpendicular to the X-direction and perpendicular to the longitudinal direction of the cantilever (4),
wherein each cantilever comprises at least one piezoelectric element (7) for providing said deflection in the X- and Y-direction by actuating the piezoelectric element (7) with at least two electrodes (8).

2. The alignment arrangement according to claim 1, wherein at least one electrode of the at least two electrodes (8) provides said deflection in the X-direction and at least one further electrode of the at least two electrodes (8) provides said deflection in the Y-direction.

3. The alignment arrangement according to claim 1, wherein each cantilever is arranged to maintain a relative position of a respective optical fiber (3) in respect of said groove (6).

4. The alignment arrangement according to claim 1, wherein the number of cantilevers (4) corresponds to the number of optical fibers (3) in the first optical component (2a).

5. The alignment arrangement according to claim 1, wherein each cantilever (4) comprises at least three electrodes (8), preferably wherein the at least three electrodes (8) comprise two active electrodes (8) and a common electrode (8).

6. The alignment arrangement according to claim 1, wherein said deflection in the X- and Y-direction is controlled by applying at least two independently controlled voltages or electrical charges to the electrodes (8).

7. The alignment arrangement according to claim 1, wherein each cantilever (4) comprises two adjacently placed beams (9) mutually connected at least at the support tip (5), each beam (9) comprising either a piezoelectric element (7) or an electrode (8) of a piezoelectric element (7).

8. The alignment arrangement according to claim 1, wherein the groove (6) of the support tip (5) has a V-shaped or curved shape cross section.

9. The alignment arrangement according to claim 1, wherein the cantilever (4) is monolithically connected with its support tip (5).

10. The alignment arrangement according to claim 1, wherein the support tip (5) is or comprises a different material than the rest of the cantilever (4).

11. The alignment arrangement according to claim 1, wherein the second optical component (2b) is any of an optical fiber (3), an optical lens, a port of an optical chip, a waveguide or an optical aperture.

12. The alignment arrangement according to claim 1, wherein the cantilever (4) has a length of between 0.5 cm-5 cm in the longitudinal direction.

13. The alignment arrangement according to claim 1, wherein the cantilever has a thickness, measured in the transverse direction, smaller than the width of the cantilever, as measured in the lateral direction, preferably wherein the thickness is less than half the width of the cantilever, more preferably, wherein the thickness is smaller than 250 μm.

14. The alignment arrangement according to claim 1, wherein multiple layers of piezoelectric material are be combined with multiple electrode layers.

15. Alignment arrangement (1) for aligning a first and a second optical component (2a, 2b),
wherein at the least the first optical component (2a) comprises at least one lens,
wherein the alignment arrangement (1) comprises a number of cantilevers

(4) wherein each cantilever is fixed at one end to the alignment arrangement (1), and at an opposite free end comprises a support tip (5) having a groove (6) for receiving a respective lens of the first optical component (2a),
wherein each cantilever (4) is arranged for deflecting in an X-direction perpendicular to the longitudinal direction of the cantilever (4), and in a Y-direction perpendicular to the X-direction and perpendicular to the longitudinal direction of the cantilever (4),
wherein each cantilever comprises at least one piezoelectric element (7) for providing said deflection in the X- and Y-direction by actuating the piezoelectric element (7) with at least two electrodes (8).

16. System for optically connecting an on-chip port of a first chip with an on-chip port of a second chip, wherein the system comprises an alignment arrangement (1) in accordance with claim 1 for aligning the on-chip port of the first chip with a first optical component (2b).

17. The system according to claim 16, further comprising a second alignment arrangement (1) in accordance with any of the preceding claims for aligning the on-chip port of the second chip with the first optical component (2b) or with a second optical component (2b); such that the first optical component (2a) is aligned with the on-chip port of the second chip via the optical component or components (2a, 2b).
